(19) United States
(12) Patent Application Publication
(10) Pub. No.: US 2014/0257968 A1
(43) Pub. Date: Sep. 11, 2014

(54) METHOD AND APPARATUS FOR DETERMINING DIGITAL MEDIA VISIBILITY

(71) Applicant: TELEMETRY LIMITED, London (GB)

(72) Inventors: Geo CARNCROSS, Ealing (GB); Russell IRWIN, London (GB); Beau Ner CHESLUK, London (GB); Anthony RUSHTON, West Byfleet (GB); Adam LUSTED, London (GB); Daniel NEE, London (GB); Paul FREEMAN, London (GB)

(73) Assignee: TELEMETRY LIMITED, London (GB)

(21) Appl. No.: 14/280,511

(22) Filed: May 16, 2014

Related U.S. Application Data
(63) Continuation of application No. 13/714,346, filed on Dec. 13, 2012.

(51) Int. Cl. G06Q 30/02; H04L 12/26; G06F 17/22

(52) U.S. Cl. CPC G06Q 30/0242; G06F 17/2247; H04L 43/08
USPC 705/14.41

(57) ABSTRACT

A method of determining whether media displayed on a web page in a web browser is visible comprising: determining whether the web page comprises at least one frame; and if the web page comprises at least one frame, using information relating to the activity of the media player to determine whether the media is visible.

### TECHNICAL FIELD

The present invention relates to methods and apparatus for determining the visibility of media on a web page shown within a web browser.

### BACKGROUND OF THE INVENTION

As a result of the increase in the number of computing devices available to users, the proportion of media viewed by the public through an internet connection has increased. It is expected in the coming years that this proportion will increase further so that a significant proportion of the media viewed by users will be viewed on electronic devices such as laptops, netbooks, tablets and mobile phones through interfaces such as web browsers.

The introduction of Personal Video Recorders (PVRs) and Digital Set-Top Boxes in recent years has decreased the effectiveness of advertisements within such traditional areas as television “ad-breaks”. The placement of advertisements to capture the emerging mechanisms for viewing media has therefore been a subject of interest within the advertising industry in recent years.

In particular, digital video advertising is increasingly used. An advertiser or advertising agency will create media, typically in the form of an advertisement, i.e. a digital video. The advertisement is distributed by a publisher who delivers the digital video content to positions within web pages to be viewed by a user. It is common for an advertiser to pay the publisher per instance of the digital video content delivered, in other terms per “impression”. However, in order for the advertiser to be confident that they are receiving value for money it is important that the digital video content is provided to the viewer in a way that enables the viewer to view media, for example in the form of digital video content.

In order to ascertain the effectiveness, and therefore the value, of an advertising campaign directed to media obtained through an internet connection, suitable metrics are required. Such metrics may include an indication of whether media, such as an advertisement, appears within the viewable window of a web browser when the web page is initially loaded. For example, the digital video content may appear in the active window of a web browser, but may be located in a part of the page that is below the bottom edge of the browser window when the web page is first loaded. If this is the case, the user must scroll down the window in order to view the media. Media that appears below or to the side of the browser window such that it is not visible when the web page first loads is known as “below-the-fold” media. Conversely, media that is visible when the web page first loads is known as “above-the-fold” media.

It is known to identify whether media is “below-the-fold” by obtaining the browser window height and width, calculating the co-ordinates of the location of the media on the web page (in pixels from the top left of the web page) and dividing the co-ordinates by the browser window dimensions to calculate the number of times the user will need to scroll a complete browser window to arrive at the digital video content. If this number is less than one, the digital video content is considered “above-the-fold” and therefore visible when the web page is first loaded.

It is not currently possible to obtain metrics for a large census of a particular advertising campaign due to the limitations with known approaches which utilise page analysis. Such techniques cannot be used in website designs where the advertisements are positioned on web pages by use of framing; for example, by using the <iframe> tag within HTML. Since the position of the media is related to the frame rather than the web page within which the frame is located the known technique above cannot be used.

### SUMMARY

According to a first aspect of the present invention, there is provided a method of determining whether media displayed on a web page in a web browser is visible to a user, the method comprising:

determining whether the media is displayed in at least one frame of the web page; and if the media is displayed in at least one frame, monitoring and analysing activity information from a user terminal to determine whether the media is visible to the user.

Preferably, said activity information comprises information relating to the activity of a media player.

Preferably, the activity information is input into a model; and wherein the model provides an estimation of whether the media is visible based upon the information relating to the activity of the media player.

Preferably, the numerical model comprises a probabilistic model.

Preferably, the numerical model comprises a regression analysis.

Preferably, the coefficients of the numerical model are determined using training data.

Preferably, the activity information relates to the activity of the media player and comprises a frame rate of the media player.

Preferably, the activity information relates to the activity of the media player.

Preferably, the activity information comprises data on a sleep mode of the media player.

Preferably, determining whether the media player is in a sleep mode comprises determining whether the frame rate is below a predetermined threshold.

Preferably, the activity information comprises total time that the media player spent in sleep mode.

Preferably, the activity information comprises the percentage of the total monitored time spent in sleep mode.

Preferably, the activity information comprises the number of transitions of the media player to sleep mode.

Preferably, the activity information comprises data on an active mode of the media player.

Preferably, determining whether the media player is in an active mode comprises determining whether the frame rate is above a predetermined threshold.

Preferably, the activity information comprises total time that the media player spent in active mode.

Preferably, the activity information comprises the number of transitions of the media player to

Preferably, the activity information comprises the percentage of the total monitored time spent in active mode.

Preferably, the media is digital media. Preferably, the media is digital video media. Preferably, the media is rich media. Preferably, the media is an advertisement.

Preferably, if the web page does not comprise at least one frame, the determination of whether the media is visible uses page analysis.

Preferably, page analysis comprises:

determining the relative location of the media on the web page; and

determining from the relative location of the media whether the media is visible.

Preferably, page analysis comprises determining the dimensions of the active window of the web browser.

Preferably, the activity information is stored with information relating to the results of page analysis to form training data for the model, when page analysis is performed.

Preferably, the stored information is used to calibrate coefficients of the model.

According to a second aspect of the invention, there is provided a method of calibrating a model for determining whether media displayed on a web page in a web browser is visible when the web page comprises at least one frame;

the method comprising using information obtained from at least one media displayed in at least one web page which does not comprise at least one frame.

Preferably, the information obtained from the at least one media displayed in at least one web page which does not comprise at least one frame comprises information obtained by page analysis.

Preferably, page analysis comprises:

determining the relative location of the media on the web page; and

determining from the relative location of the media whether the media is visible.

Preferably, the page analysis comprises determining the dimensions of the active window of the web browser.

Preferably, the method comprises monitoring and analysing activity information from a user terminal.

Preferably, the activity information is input into the model; and wherein the model provides an estimation of whether the media is visible based upon the activity information.

Preferably, the numerical model comprises a probabilistic model.

Preferably, the numerical model comprises generalised linear regression analysis.

Preferably, the coefficients of the numerical model are determined using training data.

Preferably, the coefficients are updated intermittently.

Preferably, the activity information comprises data on a frame rate of the media player.

Preferably, the activity information comprises data on a sleep mode of a media player.

Preferably, the media player is in a sleep mode comprises determining whether the frame rate is below a predetermined threshold.

Preferably, the activity information comprises the number of transitions of the media player to sleep mode.

Preferably, the activity information comprises the percentage of the total monitored time spent in sleep mode.

Preferably, the activity information comprises data on an active mode of a media player.

Preferably, the media player is in an active mode comprises determining whether the frame rate is above a predetermined threshold.

Preferably, the activity information comprises total time that the media player spent in active mode.

Preferably, the activity information comprises the number of transitions of the media player to active mode.

Preferably, the activity information comprises the number of transitions of the media player to active mode.

Preferably, the activity information comprises the percentage of the total monitored time spent in active mode.

Preferably, the media is digital media.

Preferably, the media is digital video media.

Preferably, the media is rich media.

Preferably, the media is an advertisement.

According to a third aspect of the invention, there is provided a computer readable medium bearing computer code which, when executed by a processor, causes the device to implement the method of either of the first and second aspects.

According to a fourth aspect of the invention, there is provided a data processing apparatus configured to implement the method of either of the first and second aspects.

According to a fifth aspect of the invention, there is provided a computer apparatus arranged to determine whether media displayed in a window of a web browser on a remote user terminal is visible to a user of the terminal, the apparatus comprising:

an interface configured to receive activity data from code running on a remote user terminal;

computer code operable, when executed, to cause the computer to input said activity data into a model configured to provide an indication of whether the media displayed on the remote computer is visible to a user at the remote computer; and

a calibration module arranged to receive training data to calibrate the activity data used in the model.

Preferably, the activity data received from the code running on the remote user terminal comprises data selected from one or more of: frame rate data; sleep mode data; mouse or other pointer movement data; click or other selection data; page dwell time; resource availability data; another data capable of indicating media within a at least one frame is visible to a user.

Preferably, the model is a numerical model.

Preferably, the numerical model is implemented using regression coefficients derived from the activity data.

Preferably, the regression coefficients have been calibrated based training data from page analysis of instances without a frame.

Typically, “at least one frame of a web page” means a frame displayed by a media player. In the case of the media being video content, “at least one frame of a web page” typically refers to the first or, optionally, another early frame in a sequence of frames played by the media player on a user terminal during playing out of the video.

The capability to detect whether the media is visible within a web page across a large number and variety of terminals may be used in a number of different applications, including fraud detection, auto-instantiated placements, reach estimation, and to give publishers greater strength in instantiating media as a specific product.

Media may be considered as one of a number of different types including rich media (non-video), such as images, and digital video content including interactive video. Media may also encompass videos in the form of advertisements or in other forms.

An impression, or a viewable impression, is a term used to describe a metric to report whether and how many media or advertisements are actually viewed by users.

### BRIEF DESCRIPTION OF THE DRAWINGS

The invention is diagrammatically illustrated by way of example, in the accompanying drawings in which:

FIG. 1 shows a system overview of a network for web media distribution; FIG. 2 shows a flow diagram of data acquisition from web media;

FIG. 3 shows a flow chart of determining visibility of media by page analysis;

FIG. 4 shows a flow chart of determining visibility of media by hybrid analysis;

FIG. 5 shows a timeline of playing a media through a web browser;

FIG. 6 shows a flow chart of system calibration; and

FIG. 7 shows a flow chart of performing linear regression;

### DETAILED DESCRIPTION OF THE DRAWINGS

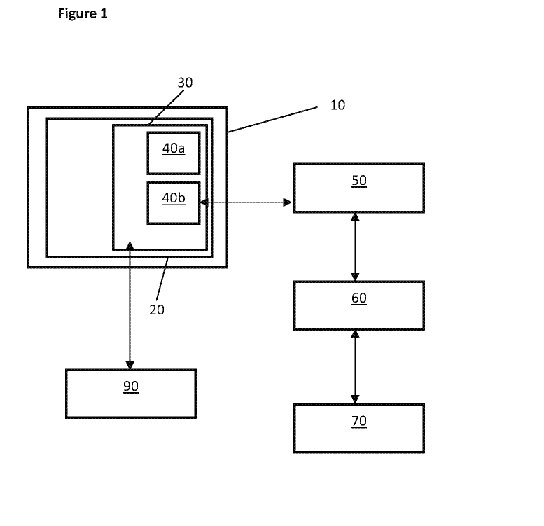

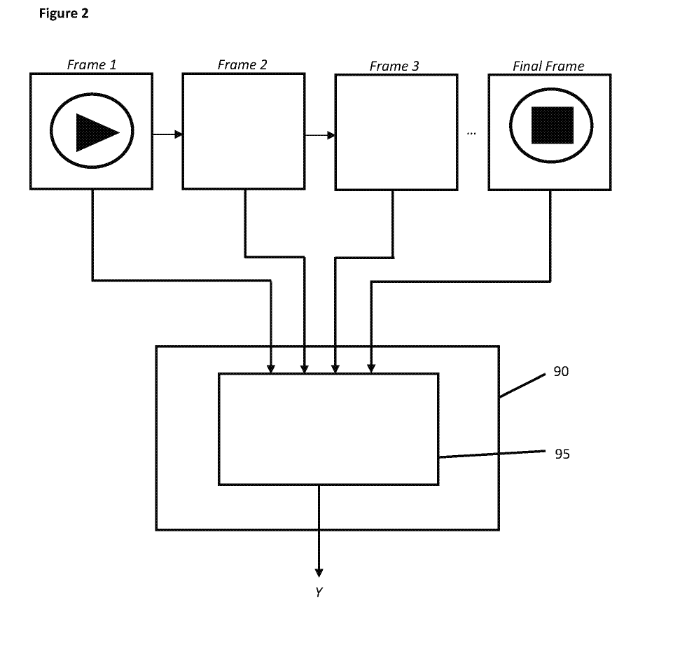

FIG. 1 illustrates a system overview of a network for distributing web media. As shown in FIG. 1, the network illustrates a user terminal 10 comprising a web browser 20. The user terminal may take the form of any electronic device which is capable of running a web browser or other interface through which web-based media may be obtained. In some embodiments, the user terminal 10 may be a desktop computer or PC. In some embodiments, the user terminal 10 may be a portable or mobile device with a wired or wireless data connection. In some embodiments, the user terminal 10 may be a tablet computing device, a netbook, a laptop or a mobile phone capable of running the web browser 20. The web browser 20 may, for example, comprise one of the following web browsers; Google Chrome™, Mozilla Firefox™, Internet Explorer™ or Safari™. This list is not intended to be exhaustive.

In use, the web browser 20 may be operated to access web pages. Some web pages may be designed with specific areas or frames of the page allocated for media to play. In some embodiments, the media may be in the form of a video. In some embodiments, the media may take the form or audio or rich media, such as an image. In some embodiments, the media may be interactive.

As discussed previously, the design of some web pages may include the use of framing in order to separate the web page into a number of discrete frames or windows. Other types of web design methodology may not make use of framing.

In arrangements where the media takes the form of an advertisement, the advertisement may be distributed through a number of different servers before it is delivered to the web browser 20. The distribution of media and particularly video media such as advertisements can be considered a marketplace of selling and re-selling of media publications.

In an exemplary arrangement, an advertiser will make an agreement with a first publisher to publish media in the form of an advertisement a fixed number of times. From this, the advertiser will distribute the media from an ad server 70 to the first publisher's server 60. The first publisher will seek to publish the advertisement to a number of user terminals, in order to fulfil the agreement. If the first publisher is unable fulfil the agreement, the first publisher may arrange the further distribution of the media with a second publisher in order to fulfil the original agreement, and the first publisher may distribute the media to the second publisher's server 50. This may then continue to a third publisher if the second publisher is unable to fulfil the original agreement, and so on.

An ad server may be considered a server, such as a web server, that operates to store media such as advertisements. Such media may be delivered to user terminals when a user visits a particular web page or website. In addition, ad servers may also act to target particular media to particular users depending upon a set of rules. Therefore, a particular media, such as a particular advertisement, may have been placed on a plurality of different ad servers in order to form a chain between the original advertiser and the publisher's ad server 50 through any number of different ad servers before being published to a particular user terminal 30. Each advertisement 40a, 40b receives media from a publisher when a web page is loaded.

Where a website utilises framing in order to locate and place media, such as an advertisement, onto a webpage it is possible to utilise an HTML tag known as an inline-frame or iframe. The iframe is effectively a window to a separate document. This document may be linked by use of the “src” attribute. It is possible to nest such iframes in order to navigate through the chain back to the original provider of the advertisement. In some embodiments, the original provider of the advertisement may be the advertiser.

It is generally not possible to obtain page information across domain name boundaries when iframes are used. Iframes are presented without knowledge of the contents of other frames for privacy or security reasons. Therefore, the use of iframes suits the network arrangement described in FIG. 1 since it is possible using iframes to supply media across the domain name boundaries of different ad servers. Furthermore, iframes make brokering possible by allowing advertisers to buy or sell media on exchanges.

Visibility Model

FIG. 2 illustrates a flow diagram of data acquisition regarding the media being played in the web page. It is possible to integrate messaging points within the video so that when particular events occur it is possible to perform calculations or transmit data to external devices or servers. This is commonly done by embedding functionality in the form of software code embedded in the media player, such as, without limitation, the use of Action Script within an Adobe™ Flash™ (swf) video.

For a particular media, such as an advertisement video, playing on a particular player, it is possible to include a number of different messaging points throughout the video. FIG. 2 shows an arrangement wherein at each of the messaging points the media player running on the user terminal transmits at least one data field to a remote server 90. It is possible to define how regularly the data packet should be sent as well as the contents of the data packet. In some embodiments, data may be sent when each frame is played. In other embodiments, messaging points may occur at alternating frames, i.e. odd or even frames. Other messaging points and messaging rates may be used.

The data transmitted may include the frame rate information or the mode of the media player (e.g. sleep or active).

The data transmitted from the user terminal 10 may be sent to a remote server 90 and forwarded to a model 95 operating on the remote server 90. The remote server 90 may comprise one or more pieces of server hardware. In some embodiments, the server hardware may perform operations on the data in parallel. In some embodiments, model 95 may be implemented in software which executes on the server 90. In some embodiments the model 95 may operate across multiple pieces of hardware so as to share the processing. In some embodiments, the remote server 90 may be configured to receive data from one or more terminals simultaneously.

The model 95 operates to receive data from the user terminal 10 which is running the media within a web browser in order to determine whether the video is visible in the browser. It is advantageous to perform the processing remotely from the user terminal 10 since the user device providing the user terminal 10 may have limited processing resources. This is particularly relevant to browsers and also to mobile devices which have reduced processing capabilities.

Other optimisations which may be monitored in order to establish whether a video is playing include a feature of Google™ Chrome™ in which the beginning of “animation frames” occur more frequently when the element being animated is visible. In addition, some 3D acceleration hardware is available to web browsers, for example through Microsoft™ Silverlight™ and the WebGL API in HTML5. However, modern graphics hardware generally only supports a single instance to be uploading shapers at a time.

These optimisations, although useful indicia of the activity and visibility of the media to be analysed, present challenges since the variability in the values may lead to misleading results. Specifically, as discussed above, user devices vary significantly in terms of performance and processing power, in addition to type of device. Therefore, the data retrieved from user devices alone may cause erroneous results. In order to allow for fluctuations and variances in system performance, the model 95 is utilised to perform statistical analysis on the data in order to determine with a greater accuracy whether the media is visible.

The output V of the model 95 provides a probability that indicates whether the media loaded by a web browser is “above-the-fold” or “below-the-fold”.

Flash Sleep Mode

As discussed above, since the user devices have limited processing capability, many optimisations are used in order to reduce the amount of data processing performed. For example, Adobe™ Flash™ uses a sleep mode when the media, such as the video, is not visible on screen. It is therefore possible to infer from the behaviour of the Flash™ sleep mode, whether the media is visible.

In some embodiments, the video may be in one of a number of different formats to be played by one of a number of different web video players. As noted above some embodiments of the video may be a .swf file used as part of the Adobe Flash™ environment. As such the video may have embedded within it computer code, such as Action Script. The Action Script may then be executed when the video file is called in order to execute the process to obtain data by querying the web browser.

In some embodiments, it is possible to ascertain whether the player is operating in a particular mode in order to infer whether the video is playing. For example, in some embodiments, the video player may enter a sleep mode when the video player is not visible on screen. With other players or browsers, the frame rate of the video player may be reduced when the player is not visible on the display of the user terminal. Put another way, the frame rate of the video player is the rate at which frames of the video are displayed on the screen. The frame rate of the video player may not be the same as the frame rate of the display screen. In practice, the frame rate of the video player may be significantly lower.

Although the discussion of sleep mode below is made in respect of Adobe™ Flash™, other combinations of browsers and video types may be considered and the principle of detecting the visibility of the media, e.g. a video, on the visible screen remains the same.

Determination of whether Adobe Flash has entered sleep mode involves calculating the frame rate at which the media is played within the browser. Experimental testing was performed across a number of browsers (including Google™ Chrome™, Internet Explorer™, Mozilla™ Firefox™ and Safari™) running on a variety of operating systems (Ubuntu™ Linux™, Mac™ OSX™ and Windows™). The results of the experimental testing found for a large number of combinations of operating system and browser that a frame rate of 2 fps was largely representative of Adobe™ Flash™ entering sleep mode. The tests also found that a frame rate of 7, 8, 9 or 10 fps operated when the Adobe™ Flash™ was not in sleep mode. It is therefore possible to select a threshold between these values in order to determine whether sleep mode has been entered or alternatively whether Flash is in sleep mode.

In order to calculate the frame rate at which the media is played, software monitors the frame rate of the video player embedded in the web page as it plays the digital media. The software embedded in the video receives an event which indicates that a frame has been delivered. For example, in Adobe™ Flash™ the “onEnterFrame” event is used. The time at which the event is received is stored. It is then possible to compare the timestamps at which different events are received in order to determine the frame rate. In some embodiments, the frame rate may be calculated across a number of frames. For example, a rolling average may be used. In some embodiments, the identification of the change from sleep mode to an active mode may require the frame rate to be above a particular threshold for a predetermined period of time.

Detection Model

As discussed above, a model is used to determine the probability of an impression at the user terminal occurring “above-the-fold” or “below-the-fold”. The determination is based upon a number of variables which are stored for the model. As described later, the variables are calibrated and optimised based upon a set of training data.

In some embodiments, the model utilises a linear regression model. While the disclosed example uses Generalised Linear Regression, any suitable regression analysis may be used, for example, without limitation, one or more of, Ordinary Least Squares, Instrumental Variables, and Ridge Regression. The model utilises the frame rate information and the Flash Sleep Mode (FSM) information obtained from the user terminal in order to calculate a number of variables for use in the model for a particular impression. Specifically, the model utilises Flash Sleep Mode (FSM) and frame rate information in order to determine the below variables prior to performing the linear regression. In some embodiments, the variables may be calculated by the software embedded in the media playing in the browser. In some embodiments, the variables may be calculated by another application running within the server 90, which passes the variables to the model.

There are many different variables which may be used in the linear regression model. One or more of the variables below may be used:

$( \frac{FPSLPTIM}{FPSLPTIM + FPWAKTIM} )$

| | | |
|---|---|---|
| X₁ | FPSLPTIM | The amount of time spent in sleep mode (ms). |
| X₂ | FPWAKTIM | The amount of time spent in active or awake mode |
| | | (ms). |
| X₃ | FPNUMWAK | The number of times the flash element transitioned |
| | | into active or awake mode. |
| X₄ | FPNUMSLP | The number of times the flash element transitioned |
| | | into sleep mode. |
| X₅ | FPSLPPRC | % of the total monitored time spent in sleep mode |

The model is in this example a simple logistic regression model, wherein the binary variable BTF is given a value of 1 for an impression occurring “below-the-fold” and 0 occurring “above-the-fold”. The probability of the impression occurring “below-the-fold” is given to be:

$$P ( BTF = 1 / X ) = \frac{1}{1 + {e}^{- {X}^{T} β}}$$

Where β are the logistic regression coefficients and X is the vector of variables defined above,

X^{T}β=β₁X₁+β₂X₂+β₃X₃+β₄X₄+β₅X₅

The process of determining the logistic regression coefficients is described in more detail later, but is determined empirically by analysis of data representative of known visible and non-visible video played across a range of circumstances.

An advantage of utilising the above approach to probabilistic estimation based on a number of variables over utilising the raw data is that the FPS data may be strongly linked to the processing performance of the user's device. The variation of system performance between users may be accounted for by utilising the regression model.

Page Analysis

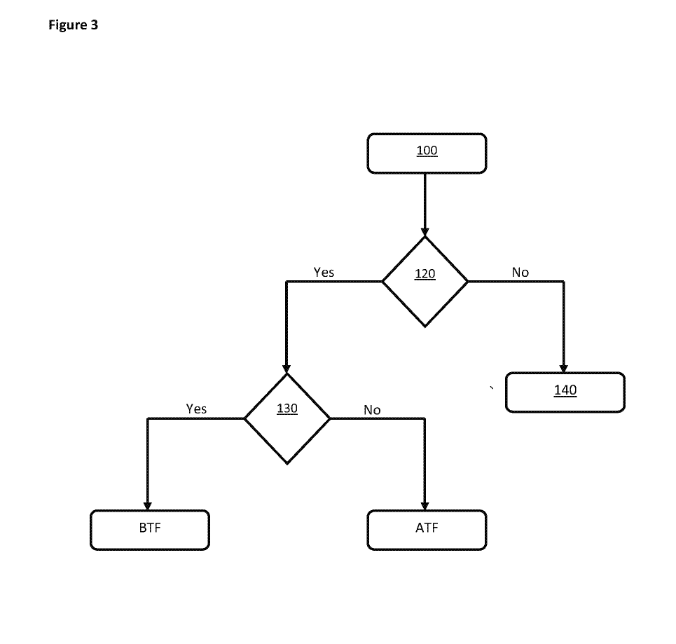

FIG. 3 illustrates a flow chart of the decision process by which the analysis is made in order to ascertain whether an advertisement is visible within a web browser.

Page analysis relies upon knowing the size of the web page relative to the browser window and the relative location of the media, such as the advertisement, with respect to the dimensions of the web page. It is common for web pages to be larger than the current visible window which is displayed on the display screen of the user terminal. In use, the user must scroll down the web page to see the content further down. Put another way, when a web page loads, there is content visible on the display screen. In some cases, media at the bottom of the page may only be partially visible since the remainder of that media may be further down the web page and thus not visible in the current browser window (the presently visible portion of the browser).

In some examples, a web page may be twice the depth of the current browser window. In this case, it is possible to scroll down the web page to reveal media and content which may not have been visible when the web page was initially loaded. In order to quantify this more closely, it is possible to separate the web page into a number of “pages”. Each page can be considered a non-overlapping rectangle which has the dimension of a browser window. It is possible to determine on which “page” of the web page the media, such as the advertisement, is placed. If the media is placed on the second page, it is necessary to scroll down the web page by the depth of a browser window in order that the media is visible. Similarly, if the media is placed on the third page, it is necessary to scroll down the web page by the depth of two browser windows in order that the media is visible.

By determining the “page” on which the media is placed within the webpage, it is possible to determine whether the advertisement is “above-the-fold” or “below-the-fold”. Advertisements are typically referred to as “below-the-fold” if, when the web page loads, the advertisement is not located on the visible portion of the browser window. As such, it is necessary for the user to scroll down the web page in order for the advertisement to be visible. Conversely, the advertisement is considered to be “above-the-fold” if, when the web page is loaded, the advertisement is located on the first “page” of the web page. Put another way, an “above-the-fold” advertisement is visible in the browser window when the web page is loaded.

Whether a particular piece of media appears “below-the-fold” or “above-the-fold” is a particularly useful metric in determining whether the media was viewed by the user. It is common for users to follow a link or move to a different web page before scrolling down the web page. Users commonly do not view or take note of media which appears further down a web page. Therefore, determining whether media appears above or “below-the-fold” can be a powerful indicator as to whether media has been viewed on a web page by a particular user.

In embodiments where the publication of the media is in the form an advertisement, the advert may not be paid for if it appears “below-the-fold”.

The page analysis methodology illustrated in FIG. 3 has proved to be a very reliable method for the determining whether a particular media is “below-the-fold” for web pages where the media is not placed within a frame, such as an HTML <iframe>. As illustrated in FIG. 3 the process begins by starting the analysis at step 100. The second step in the process 120 is to determine whether the advertisement appears within a frame, such as an <iframe>, or is placed directly at a position on the web page. It is not possible to determine the relative location of the media with respect to the remainder of the web page if the media is in an iframe since the content of the iframe is logically isolated within the iframe. Without knowledge of the relative location of the media, it is not possible to determine which “page” (i.e. the position of the media relative to the total depth) of the web page the advertisement appears on. If this is the case, then page analysis cannot be performed and an error is returned at step 140.

There are many mechanisms for determining whether the web page utilises iframes in order to determine whether page analysis may be used. For example, it is possible to parse the HTML to identify the <iframe> tag or alternatively traverse the parent and window Javascript objects. It is also possible to determine whether the web page uses frames by analysing whether WINDEPTH (the window depth) is equal to zero. If (WINDEPTH==0) then it is possible to use page analysis without getting significantly erroneous results. However, if WINDEPTH is not zero (WINDEPTH!=0) then it is not possible to use page analysis.

Using page analysis at step 130, the position of the digital media within the web page is determined. In some embodiments, it is possible to determine the position of the media to be played by determining the number of pixels from the top-left corner of the web page to the digital media. In addition, the browser window width and height is determined. The browser window is the window of the browser which is displayed on the display screen. This may be determined by the resolution of the display screen and also the proportion of the display screen which is used by the web browser.

At step 130 it is then possible to determine the position of the digital media relative to the current display in the browser window. Specifically, it is possible to determine whether the media is located in the first “page” (visible portion) of the web page. Therefore, if the media, such as the advertisement, is identified to be on the second or later “page” of the particular web page, then the media is determined to be “below-the-fold”. However, if the digital media is determined to be located on the first page of the web page, then it is determined that the digital media is “above-the-fold”.

In some embodiments an equal cost model for misclassifications is used. Broadly, it is desirable to avoid false positive results, e.g. minimising the number of “above-the-fold” impressions classified as “below-the-fold”. In some embodiments it is possible to use different cost functions in order to minimise false positives or negatives.

Hybrid Approach

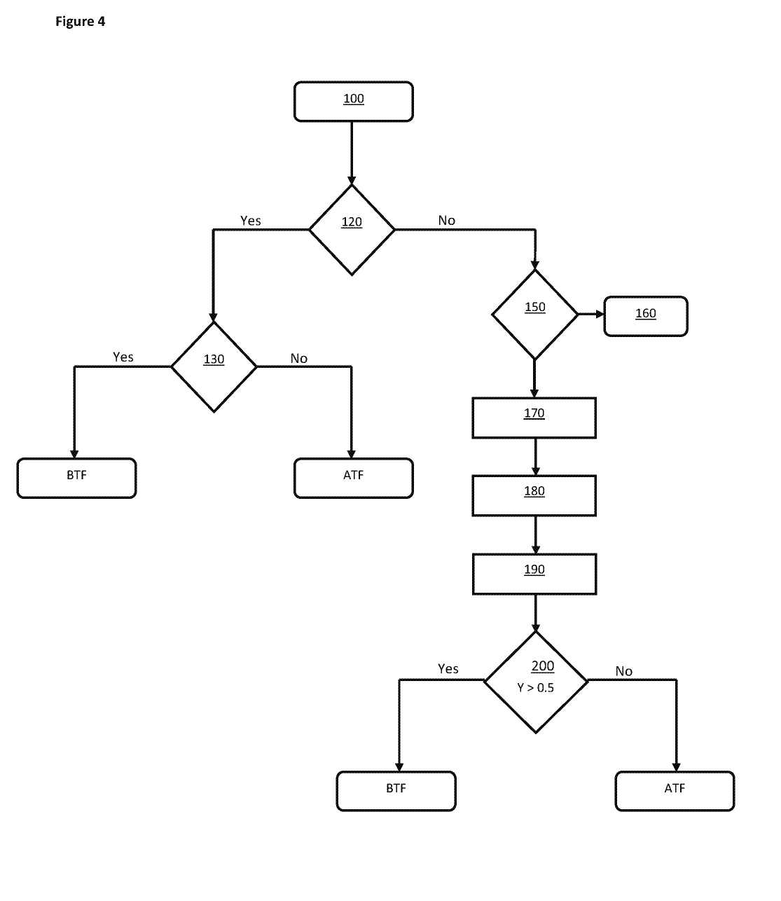

FIG. 4 is a flow chart in which a hybrid approach for determining the visibility of digital media is shown. As discussed previously, page analysis is a reliable mechanism for determining whether digital media is visible on a web page. However, as previously discussed, it is not possible to determine whether a particular digital media is visible if the web page utilises framing. Therefore, in known arrangements, no metrics are available in circumstances where page analysis is unavailable.

FIG. 4 illustrates a hybrid arrangement which different analysis method is used for web pages where it is not appropriate to utilise page analysis, for example web pages which utilise framing such as iframes.

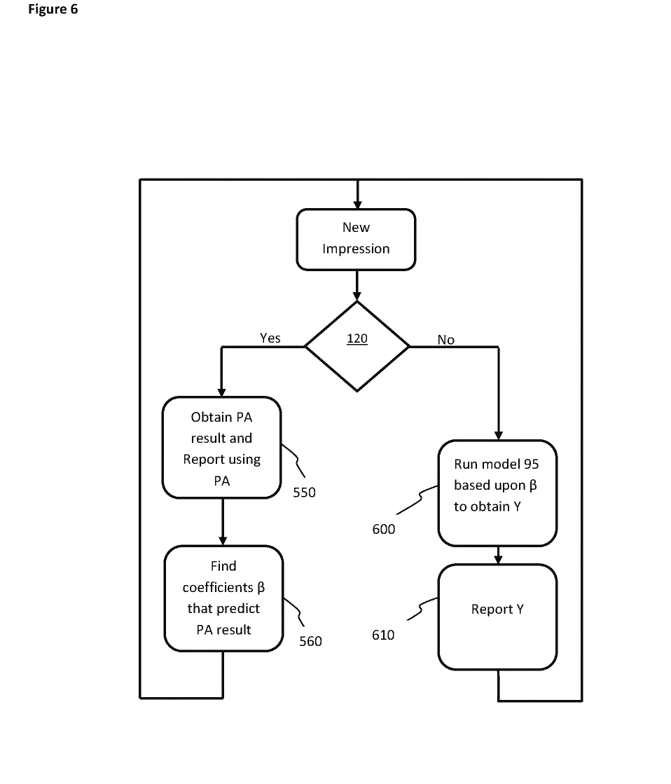

Steps 120 and 130 of FIG. 4 are the same as steps 120 and 130 described in FIG. 3, where the page analysis is used to determine whether media is “above-the-fold” or “below-the-fold”. The difference between step 120 of FIG. 3 and step 120 of FIG. 6 is that in the hybrid approach of FIG. 4, an error is not automatically raised.

Specifically, if it is determined at step 120 that the web page does use framing, then the hybrid process of FIG. 4 proceeds to step 150. Step 150 ascertains the browser type and version number and then checks the information to ascertain whether the hybrid method may be applied to the particular version used by the user terminal.

Since there are many different browser types and versions, it is not always feasible to reliably test and determine that the method works for all browser types. Further, a large proportion of users are likely to use one of the few, more popular browsers. Therefore, it is more effective to develop the method for the more commonly used browser types.

Therefore, if the browser type or version is determined to be unsupported by the hybrid method then the process will proceed to step 160 in which an error will be returned indicating that the method was unable to determine whether the media was visible to the user. Such a result will reduce the census size of the particular metric.

If the browser type or version is determined to be supported by the hybrid method, then the process will proceed to step 170. At step 170, the variables which are input into the model 95 are obtained as described earlier with respect to FIG. 2. The variables which are obtained may comprise one or more of: FPSLPTIM, FPWAKTIM, FPNUMWAK, FPNUMSLP and FPSLPPRC. Having obtained these variables for a particular impression, the process proceeds to step 180 in which the values of the variables are checked. In some embodiments, the values of FPNUMWAK or FPNUMSLP are checked to ensure that the values are not negative. If this is the case, they are replaced with zero.

The process then proceeds to step 190 in which the model is run to determine P(BTF=1|X). Put another way, the model is run to determine the probability that the impression occurred “below-the-fold”. The result of the model will be a decimal value which is assigned to ‘Y’ within the range and will take a value in the range 1≧Y≧0.

The process then proceeds to step 200 in which the value Y is assessed to determine whether it is greater than 0.5. If Y is greater than 0.5, then the impression is determined to be “below-the-fold”. If the Y is less or equal to 0.5, then the impression is determined to be “above-the-fold”, i.e. visible.

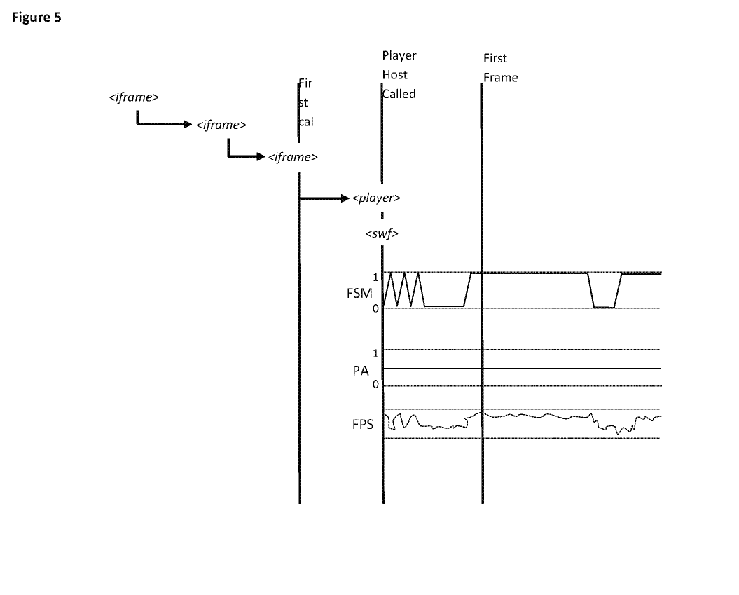

FIG. 5 illustrates a time line of activity when media is requested by a web page. As discussed previously, in some embodiments it is possible to cross domains by utilising iframes. This enables the media to be called through a chain of ad servers which are each operated by different publishers, as described with respect to FIG. 1. The iframes are called until the iframe call reaches a resource on the server 70 which hosts the media to be played. The point at which the call reaches the server 70 is referred to as the “first call” and initiates the process of loading the media to be provided to the web page. The next step of the time line is to call the player host. In the exemplary time line of FIG. 5, the player host is called to load a swf video file which is forwarded to the web page through the iframe transitions across domains.

In the exemplary arrangement of FIG. 5, Abode Flash sleep mode is utilised in order to determine whether the media is visible. In this way, when the video player is called, the software code embedded in the player begins to execute, thereby generating information relating to Flash sleep mode (FSM), page analysis (PA) and frames per second (fps) for a particular media. This information is then transmitted from the user terminal to the model 95 for processing.

The next significant point in the time line is the “first frame”, which indicates that the media has begun playing. In some embodiments, the information, such as sleep mode, page analysis and frame rate that is obtained prior to the delivery of the first frame may be used to determine whether to begin playing the media. In some embodiments, the information obtained prior to the delivery of the first frame may be discarded or not utilised. The information obtained after the “first frame” point may be used to determine whether the media is being played “above-the-fold” or “below-the-fold”.

As shown in FIG. 5, the sleep mode data is in the form of binary information. In this way, a ‘1’ is indicative of Abode Flash operating in a sleep mode, whilst a ‘0’ is indicative of Adobe Flash operating in an active mode. Similarly, the page analysis data, when available, is binary information indicating whether the media is located “below-the-fold” or “above-the-fold”. Where the page analysis data is not available, an error message is returned. The frame rate data is not binary data, and may take any number within the capabilities of the video player, the display screen of the user device and the web browser. For example, the frame rate may be between 0 fps and 50 fps. As discussed previously, the sleep mode data does not necessarily directly follow the frame rate data since the sleep mode data may be determined by calculating the frame rate across a number of frames or by virtue of a weighted average. As such, it there may be some lag between frame rate changes and determination of change in mode between active and sleep mode for Abode Flash.

Calibration

As discussed above, where web pages are configured so that page analysis is not available, for example where the web pages utilises framing, it is possible to determine whether media is visible on a web page by other methods. A hybrid approach to determining the visibility of media is described earlier, in which a model is used to determine an estimate of the probability that a particular media is visible based upon the frame rate and mode of the player.

In some embodiments, a linear regression model is used to calculate the probabilistic estimation. In order to use the linear regression model effectively, it is necessary to calibrate the model to a known data set by determining the logistic regression coefficients, β, using training data.

FIG. 6 illustrates a flow chart of the calibration process to determine the regression coefficients β. The calibration process is performed as part of the analysis of media loaded into a web page, so that real data can be utilised. The calibration process begins with by performing step 120, in which it is determined whether it is possible to use page analysis to determine whether media is visible on a web page, as described earlier.

If it is possible to use page analysis, the process proceeds to step 550 and performs page analysis to determine whether the media is “above-the-fold” or “below-the-fold”. The result of the page analysis is reported as described above. The calibration process then proceeds to step 560, which involves finding the regression coefficients that predict the page analysis result.

In some embodiments, the step of finding the regression coefficients β may be performed after each particular impression so that the regression model is regularly updated. However, this process is processor-intensive since, in practice, large numbers of impressions occur each day. Therefore, in some embodiments the process of updating the regression coefficients β in order to calibrate the model 95 may be “batched” so that the calibration occurs periodically by preparing a set of training data. For example, the calibration process may occur daily, weekly, bi-weekly or monthly. The calibration process may be performed off-line or on separate hardware so as to not impact the functionality of the server 90.

The training data is taken when page analysis is performed and is stored for calibration at a later date. The training data is obtained when page analysis is performed and involves storing the result of the page analysis, i.e. whether the media appeared “below-the-fold” or “above-the-fold”. Stored with the result of the page analysis is the data which forms the vector of variables X which is input into the model. In some embodiments, the data stored may be in the form of the frame rate and the sleep mode data. In other embodiments, each of the variables FPSLPTIM, FPWAKTIM, FPNUMWAK, FPNUMSLP and FPSLPPRC may be stored.

As shown in FIG. 6, the coefficients are updated and the process returns to the “New Impression” step in order to process the next impression. The processing of the next impression, i.e. the next media placed within a web page involves proceeding to step 120 again, in which it is determined whether page analysis can be used to determine whether the media is “below-the-fold” or “above-the-fold”. If is determined that page analysis cannot be used to determine the visibility of the media on the web page, the process proceeds to obtain the data such as FPS and FSM for the particular impression. The FPS and FSM information can be used to determine the vector of variables X. As a result of obtaining this information, it is possible to run the model, such as the linear regression model, by retrieving the updated coefficients β.

The linear regression is therefore performed at step 600 to obtain V, the output of the model, which is indicative of whether the impression is “above-the-fold” or “below-the-fold”. After reporting the result of the model at step 610, the process returns to the start of the process and the process is started again.

The calibration process is therefore iterative, in that the regression coefficients are determined from when page analysis is performed. These coefficients are then used when page analysis is not available. Since the results of page analysis are reliable, they form a strong data set against which the model can be calibrated and verified. In this way, data which would normally be obtained when page analysis is unavailable, can be obtained when page analysis is available. It is therefore possible to verify the result of performing the linear regression against the known and accurate result of page analysis.

The assumption that allows this calibration process to be performed is that the behaviour of the media to be played will be the same, whether the web page incorporates framing or not. For example, it is assumed that media which is presently positioned “below-the-fold” in a web page will reduce in frame rate regardless of whether the media is located within a frame or not. Since the system is able to determine with accuracy whether media not in a frame is “below-the-fold”, the system can use this information to verify to particular degrees of accuracy whether the results accurately reflect that of the page analysis.

For example, in some embodiments, it is possible to determine whether the results of the linear regression model for a particular set of coefficients are equal to or above 95% across the complete training dataset. If this is the case, then coefficients may be deemed to be acceptable for use within the model. In other embodiments, other thresholds may be determined, such as equal to or greater than 85%, 90%, 91%, 92%, 93%, 94%, 96%, 97%, 98% or 99%. Based on this description, a skilled person will understand that choice of percentage threshold will be informed by the level of confidence in the statistically derived results.

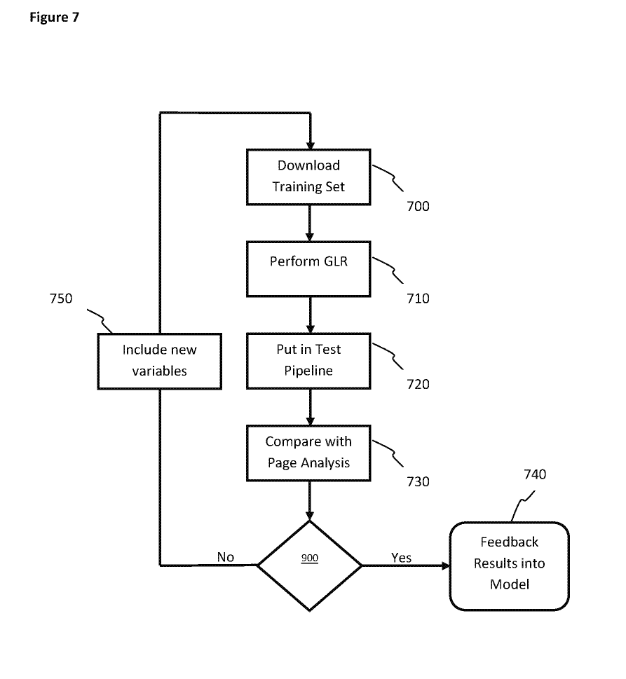

FIG. 7 illustrates a flow chart of a method for determining the regression coefficients β. As discussed earlier, this process may be performed in real-time, but more practically is performed off-line on a periodic basis. In some embodiments, this process may be performed when a new operating system or browser type or version is released in order to broaden the training set to encompass the new data.

The process of the determining the regression coefficients begins at step 700 by obtaining, by download or otherwise, the training set. The training data set is formed of the result of the page analysis, i.e. whether the media is located “above-the-fold” or “below-the-fold”. The training data also comprises the frame rate and sleep mode data obtained for the same impression.

At step 710, the training data is then input into the linear regression model, so that for each impression which exists within the training data, a corresponding V value is produced as a decimal number between 0 and 1. The outputs, V, of the linear regression model are placed into a test pipeline 720 and are placed alongside the corresponding results of the page analysis. Each impression is therefore labelled as either viewable or non-viewable.

The process then proceeds to the comparison step 730 where, for each impression, the result of page analysis and the result of linear regression is compared to see whether they agree. For example, if both the page analysis and the and linear regression outputs confirm that the media was not visible on the web page, i.e. “below-the-fold”, then the outputs agree. This comparison is performed across all of the impressions in the dataset and a percentage of agreement is determined for the training data set. In some embodiments, assessment of the predictive performance is done using 10 fold cross validation.

The results of the comparison are reviewed at step 900 and if the results are deemed acceptable, i.e. the results are of a sufficient accuracy for the particular application, the results of the calibration are fed back into the model 95 at step 740. Put another way, the newly updated coefficients are placed into the model and will be used thereafter for determining the visibility of media.

If it is determined at step 900 that the results are not sufficient for the particular application, the process is repeated. Before repeating the process, further variables may be included in step 750. In the illustrated examples shown above, the number of variables used totalled five; namely FPSLPTIM, FPWAKTIM, FPNUMWAK, FPNUMSLP and FPSLPPRC. In some embodiments, only a subset of these five variables may be deemed of sufficient accuracy for a particular application. In some embodiments, more than five variables may be required in order to determine whether media on a web page is visible to the user. Other variables which may be used in the linear regression model include any suitable variable tracked by the system including, but not limited to, the presence of mouse or other pointer movement, animation frame rate, clicks, page dwell-time (how long a user sits on the page), and resource acquisition success/availability (such as in the case of 3-D hardware).

Those skilled in the art will appreciate that while the foregoing has described what are considered to be the best mode and, where appropriate, other modes of performing the invention, the invention should not be limited to specific apparatus configurations or method steps disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognize that the invention has a broad range of applications, and that the embodiments may take a wide range of modifications without departing from the inventive concept as defined in the appended claims.

We claim:

1. A method of determining whether media displayed on a web page in a web browser is visible to a user, the method comprising:
determining whether the media is displayed in at least one frame of the web page; and
if the media is displayed in at least one frame, monitoring and analysing activity information from a user terminal to determine whether the media is visible to the user.

2. A method according to claim 1, wherein said activity information comprises information relating to the activity of a media player.

3. A method according to claim 2, wherein the activity information is input into a model; and wherein the model provides an estimation of whether the media is visible based upon the information relating to the activity of the media player.

4. A method according to claim 3, wherein the model is a numerical model.

5. A method according to claim 4, wherein the numerical model comprises a probabilistic model.

6. A method according to claim 4, wherein the numerical model comprises a regression analysis.

7. A method according to claim 4, wherein the coefficients of the numerical model are determined using training data.

8. A method according to claim 2, wherein the activity information relates to the activity of the media player and comprises a frame rate of the media player.

9. A method according to claim 2, wherein the activity information relates to the activity of the media player.

10. A method according to claim 9, wherein the activity information comprises data on a sleep mode of the media player.

11. A method according to claim 10, wherein determining whether the media player is in a sleep mode comprises determining whether the frame rate is below a predetermined threshold.

12. A method according to claim 10, wherein the activity information comprises total time that the media player spent in sleep mode.

13. A method of calibrating a model for determining whether media displayed on a web page in a web browser is visible when the web page comprises at least one frame; the method comprising using information obtained from at least one media displayed in at least one web page which does not comprise at least one frame.

14. A method according to claim 13, wherein the model is a numerical model.

15. A method according to claim 13, wherein the information obtained from the at least one media displayed in at least one web page which does not comprise at least one frame comprises information obtained by page analysis.

16. A method according to claim 15, wherein page analysis comprises: determining the relative location of the media on the web page; and determining from the relative location of the media whether the media is visible.

17. A method according to claim 15, wherein the page analysis comprises determining the dimensions of the active window of the web browser.

18. A method according to claim 13, wherein the method comprises monitoring and analysing activity information from a user terminal.

19. A method according to claim 18, wherein the activity information is input into the model; and wherein the model provides an estimation of whether the media is visible based upon the activity information.

20. A method according to claim 18, wherein the numerical model comprises a probabilistic model.

21. A method according to claim 14, wherein the numerical model comprises generalised linear regression analysis.

22. A method according to claim 14, wherein the coefficients of the numerical model are determined using training data.

23. A method according to claim 22, wherein the coefficients are updated intermittently.

24. A method according to claim 18, wherein the activity information comprises data on a frame rate of the media player.

25. A method according to claim 18, wherein the activity information comprises data on a sleep mode of a media player.

26. Computer apparatus arranged to determine whether media displayed in a window of a web browser on a remote user terminal is visible to a user of the terminal, the apparatus comprising:
an interface configured to receive activity data from code running on a remote user terminal;
computer code operable, when executed, to cause the computer to input said activity data into a model configured to provide an indication of whether the media displayed on the remote computer is visible to a user at the remote computer; and
a calibration module arranged to receive training data to calibrate the activity data used in the model.

27. Computer apparatus as in claim 26, wherein the activity data received from the code running on the remote user terminal comprises data selected from one or more of: frame rate data; sleep mode data; mouse or other pointer movement data; click or other selection data;
page dwell time; resource availability data; another data capable of indicating media within a at least one frame is visible to a user.

28. Computer apparatus as in claim 26, wherein the model is a numerical model.

29. Computer apparatus as in claim 28, wherein the numerical model is implemented using regression coefficients derived from the activity data.

30. Computer apparatus as in claim 29, wherein the regression coefficients have been calibrated based training data from page analysis of instances without a frame.
